(19) United States
(12) Patent Application Publication
(10) Pub. No.: US 2007/0111009 A1
(43) Pub. Date: May 17, 2007

(54) Multilayer composite structure with epoxide containing adhesive layer

(76) Inventors: Barry A. Morris, Wilmington, DE (US); Julius Uradnisheck, Glen Mills, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/280,565

(22) Filed: Nov. 16, 2005

(51) Int. Cl. B32B 27/36; B32B 27/06

(52) U.S. Cl. 428/412; 428/480

(57) ABSTRACT

The present invention is a multilayer composite structure comprising at least three layers, two of which are adhered to an intervening adhesive layer comprising a copolymer obtained by copolymerizing from about 55 to about 95 weight % ethylene with from about 0.1 to about 10 weight % of an epoxide-containing monomer, and optionally from 0 to about 35 weight % (meth)acrylate ester. Preferred epoxide-containing monomers are glycidyl methacrylate monomers.

### FIELD OF THE INVENTION

The invention relates to multilayer composite structures. The invention particularly relates to a multilayer composite structure comprising a thermoplastic copolymer adhesive layer obtained from ethylene and an epoxide-containing monomer.

### BACKGROUND OF THE INVENTION

High barrier packaging applications frequently utilize multilayer polymer compositions prepared by coextrusion or lamination, where the several polymer layers are adhered together with adhesive (or “tie”) resin.

Polymers referred to as barrier resins are utilized in these composite structures to provide barriers to oxygen, water, water vapor and carbon dioxide, for a variety of applications requiring barriers against these materials.

A standard oxygen barrier resin used in coextruded structures is ethylene/vinyl alcohol copolymer (EVOH). However the barrier performance of EVOH declines at high relative humidity, and permanent loss of barrier performance can occur under retort sterilization conditions. In contrast, it is well known that some aromatic polyesters have lower oxygen permeability and maintain barrier performance in wet environments.

One of the hurdles for adopting liquid crystal polymers, particularly aromatic polyester liquid crystal polymers, for coextruded barrier sheets is the development of suitable tie resins to bond the liquid crystal polymer to the other layers in the structure.

A tie resin needs to meet a number of performance requirements. For retortable barrier sheet thermoforming these include:

a) Adhesion to the barrier resin sheet of 3 to 5 lb/in;

b) Adhesion to barrier resin after thermoforming of about 1 lb/in;

c) Adhesion to structural layer polymer sheet of 3 to 5 lb/in;

d) Adhesion to structural layer polymers after thermoforming of about 1 lb/in;

e) Maintenance of functionality during retort (121° C. for 30 minutes or more);

f) Absence of delamination or distortion;

g) Matching flows of barrier resin and structural polymer resins during coextrusion to eliminate flow instabilities caused by viscosity mismatches;

h) Compliance with appropriate food regulations (FDA, European); and

i) Organoleptic properties that minimize the impartation of odor and flavor to the product and/or minimize scalping of flavor components from the product.

U.S. Pat. No. 4,497,856 discloses multi-layered containers including an inner layer of a thermoplastic fluorocarbon resin, an outer layer of polyolefin, and an intermediate layer therebetween of a mixture of either polyolefin grafted with an unsaturated glycidyl compound or an ethylene copolymer grafted with an unsaturated glycidyl compound.

U.S. Pat. No. 6,689,483 teaches the use of zeolites to scavenge unreacted acid in acid copolymers.

U.S. Pat. No. 5,053,457 describes a coextrudable adhesive composition consisting essentially of:

(a) about 60 to about 95 percent of a blend of: (i) about 1 to 100 percent by weight of a copolymer of ethylene with about 5 to about 40 weight percent of at least one copolymerized alkyl acrylate or methacrylate comonomer and a grafted comonomer containing pendant carboxylic acid or carboxylic acid anhydride functionality, wherein the amount of said grafted comonomer comprises about 0.03 to about 2.0 percent by weight of the total adhesive composition, and (ii) 0 to about 99 percent by weight of a copolymer of ethylene with about 5 to about 40 weight percent of at least one alkyl acrylate or methacrylate comonomer, wherein the copolymer of (i) and the copolymer of (ii) are mutually compatible; and

(b) about 5 to about 40 weight percent of a copolymer of about 40 to about 95 percent by weight ethylene with at least one comonomer selected from the group consisting of alpha olefins, nonconjugated dienes in an amount of 0 to about 10 weight percent, vinyl esters of carboxylic acids, styrene, alkyl acrylates, and alkyl methacrylates, wherein component (b) is incompatible with component (a).

Component (b) may be a copolymer of ethylene and at least one alkyl acrylate or methacrylate comonomer wherein such copolymer differs from the copolymers of (a) in further comprising a comonomer selected from the group consisting of acrylic acid, methacrylic acid, a monoalkyl ester of an unsaturated dicarboxylic acid, glycidyl acrylate, and glycidyl methacrylate.

U.S. Pat. No. 6,312,772 contains an example describing preparation of a multilayer laminate having the following five layer structure: high density polyethylene(HDPE), 3 mil/adhesive, 1 mil/a wholly aromatic, amorphous, thermotropic liquid crystalline polyester, 2 mil/adhesive, 1 mil/HDPE, 3 mil. The adhesive was a polyethylene-co-glycidyl methacrylate (LOTADER AX8840 available from Elf Atochem, North America, Inc.)

The present invention is directed to innovative multilayer composite structures that possess the properties listed above.

### SUMMARY OF THE INVENTION

The present invention is directed to a multilayer composite structure having at least three layers wherein two of the at least three layers are adhered to a third intervening adhesive layer comprising: a thermoplastic copolymer of monomers comprising from about 55 to about 95 weight % ethylene, from 0 to about 35 weight % alkyl methacrylate or alkyl acrylate and from about 0.1 to about 10 weight %, preferably from about 2 to about 10 weight %, epoxide containing monomer, preferably wherein the alkyl group in the alkyl methacrylate or alkyl acrylate contains from 1 to 10 carbon atoms; optionally further comprising elastomeric polymer; optionally further comprising tackifying resin; and optionally further comprising zeolite.

Preferably the epoxide containing monomer comprises a glycidyl moiety; more preferably it comprises glycidyl methacrylate or acrylate and most preferably glycidyl methacrylate. In a preferred embodiment the copolymer contains less than about 30 ppm, preferably less than about 20 ppm of residual (that is, unreacted) glycidyl methacrylate or acrylate.

In a preferred embodiment the epoxide containing monomer comprises glycidyl methacrylate, and the alkyl methacrylate or alkyl acrylate, when present, comprises n-butyl acrylate. In one aspect of this embodiment the adhesive layer copolymer contains from about 1 to about 35 weight %, alternatively from about 5 to about 25 weight % or alternatively from about 25 to about 35 weight % polymerized n-butyl acrylate, and contains less than about 10 ppm, preferably less than about 5 ppm, unreacted residual n-butyl acrylate. In another aspect of this embodiment, the adhesive layer copolymer contains from about 25 to about 35 weight % polymerized n-butyl acrylate and contains less than about 20 ppm of unreacted glycidyl methacrylate and less than 10 ppm unreacted n-butyl acrylate.

The optional elastomeric polymer is preferably a polymer from the group of: elastomeric polyolefins such as polypropylenes; ethylene copolymers such as ethylene butylacrylate (EBA), ethylene methylacrylate (EMA), and ethylene vinyl acetate (EVA) for example; ethylene/propylene/diene terpolymer rubber, polyethylene plastomers, ethylene/propylene rubber and very low density polyethylene.

It is preferred that the optional tackifying resin has a ring and ball softening point, as determined according to ASTM E-2858T, of from about 0° to about 150° C. and is selected from the group consisting of alicyclic or aliphatic hydrocarbon resin, aromatic hydrocarbon resins, rosin and rosin derivatives, and terpene resins.

Preferably the zeolite, when present, is at a level of from about 0.5 to about 5 weight % based on the weight of the adhesive layer.

Preferably at least one of the layers adhered to the adhesive layer comprises a resin selected from the group consisting of nylon 6, MXD6 nylon, amorphous nylon, ethylene/vinyl alcohol copolymers, ethylene/norbornene copolymers, polyvinylidene chloride, polypropylene, polyethylene, ethylene copolymers, ionomers, polystyrene, polyamides and polyesters.

In a preferred embodiment at least one of the layers adhered to said adhesive layer comprises a polyester selected from the group consisting of: (a) polycarbonates; (b) amorphous polyester of terephthalic acid, isophthalic acid, 1,4-cyclohexanedimethanol, and ethylene glycol; (c) poly(glycolic acid); d) polyethylene terephthalate; (e) polyethylene naphthalate; (f) polytrimethylene terephthalate; (g) poly(lactic acid); (h) polyesters from polymerization of bisphenol-A, isophthalic acid, and terephthalic acid; (i) polybutylene terephthalate; (j) polyester elastomer copolymers of terephthalic acid, butanediol, and polyalkylene glycol; (k) polyethylene carbonates from copolymerization of carbon dioxide and epoxide monomers; (l) polyesters from copolymerization of terephthalic acid or esters thereof with 1,4-cyclohexanedimethanol; and (m) polyesters based on isosorbide. The polyester may be a liquid crystal polymer.

A particularly preferred polyester is a copolymer comprising repeat units of the formulae

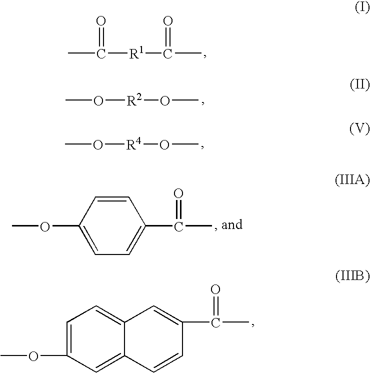

wherein:

each R¹ is independently hydrocarbylene or substituted hydrocarbylene;

each R² is independently saturated hydrocarbylene or substituted saturated hydrocarbylene;

each R⁴ is independently arylene or substituted arylene;

(V) is about 0.4 to about 32 mole percent of the total of (I) present;

the molar ratio of (I):[(II)+(V)] is about 1.0:1.0;

the molar ratio of (I):[(IIIA)+(IIIB)] is about 1.0:1.0 to about 1.0:4.0; and

the molar ratio of (IIIA):(IIIB) is about 5:1 to about 1:2.

More preferably, from 90 to 100 mole percent of R¹ is p-phenylene, and from 0 to 10 mole percent of R¹ is m-phenylene;

from 90 to 100 mole percent of R² is —CH₂CH₂— and from 0 to 10 mole percent of R² is —CH₂CH₂OCH₂CH₂—;

each R⁴ is 4,4′-biphenylene;

(V) is from about 1 to about 3 mole percent of the total of (I) present;

the molar ratio of (I):[(II)+(V)] is about 1.0:1.0; and the total amount of the repeat unit (I+V) plus the repeat unit (I+II) is from about 25 to about 35 mole percent of said copolymer;

the amount of (IIIA) is from about 45 to about 55 mole percent of said copolymer; and

the amount of (IIIB) is from about 15 to about 25 mole percent of said copolymer.

Even more preferably, the total amount of the repeat unit (I+V) plus the repeat unit (I+II) is from about 28 to about 32 mole percent of said copolymer;

the amount of (IIIA) is from about 48 to about 52 mole percent of said copolymer; and

the amount of (IIIB) is from about 18 to about 22 mole percent of said copolymer.

Particularly preferred polyesters are: (a) those prepared from monomers comprising polyethylene terephthalate, hydroxybenzoic acid, hydroxynaphthoic acid and 4,4′-biphenol; (b) those prepared from monomers comprising hydroxybenzoic acid, hydroxynaphthoic acid, 4,4′-biphenol, resorcinol and terephthalic acid or ester thereof; (c) those prepared from monomers comprising hydroxybenzoic acid, hydroxynaphthoic acid, isophthalic acid or an ester thereof, terephthalic acid or an ester thereof, and hydroquinone; and (d) those prepared from monomers comprising p-hydroxybenzoic acid, m-hydroxybenzoic acid and 6-hydroxy-2-naphthoic acid.

Preferably the alkyl methacrylate or alkyl acrylate ester of the adhesive layer copolymer comprises a C₁-C₁₀ alkyl methacrylate or acrylate ester, and more preferably comprises n-butyl acrylate.

The invention also relates to articles comprising the multilayer composite, the articles preferably being retortable packages, blister packages and flexible wrapping film.

In another embodiment the invention relates to a copolymer of monomers comprising from about 55 to about 95 weight % ethylene, from 0 to about 35 weight %, preferably from about 1 to about 35 weight %, alternatively from about 5 to about 25 weight % or alternatively from about 25 to about 35 weight % alkyl methacrylate or alkyl acrylate and from about from about 0.1 to about 10 weight %, preferably from about 2 to about 10 weight %, glycidyl methacrylate, wherein the copolymer contains less than about 30 ppm, preferably less than about 10 ppm, residual unpolymerized glycidyl methacrylate.

In one aspect of this embodiment the copolymer comprises from about 25 to about 35 weight % n-butyl acrylate as the alkyl acrylate and contains less than about 20 ppm, preferably less than about 10 ppm, residual unpolymerized n-butyl acrylate.

In yet another embodiment the invention relates to a process for reducing the residual unreacted monomer in a copolymer of monomers comprising from about 55 to about 95 weight % ethylene, from 0 to about 35 weight %, preferably from about 1 to about 35 weight %, more preferably from about 5 to about 25 weight % and even more preferably from about 25 to about 35 weight % alkyl methacrylate or alkyl acrylate and from about from about 0.1 to about 10 weight %, preferably from about 2 to about 10 weight %, glycidyl methacrylate, comprising washing the polymer with heated water in a devolatilizing extruder.

The invention also relates to a process for reducing the residual unreacted monomer in a copolymer of monomers comprising from about 55 to about 95 weight % ethylene, from 0 to about 35 weight %, preferably from about 1 to about 35 weight %, more preferably from about 5 to about 25 weight % and even more preferably from about 25 to about 35 weight % alkyl methacrylate or alkyl acrylate and from about from about 0.1 to about 10 weight %, preferably from about 2 to about 10 weight %, glycidyl methacrylate, comprising adding to and dispersing into the copolymer from about 0.5 to about 5 weight % zeolite based on the weight of the copolymer.

### DETAILED DESCRIPTION OF THE INVENTION

Applicants specifically incorporate the entire content of all cited references in this disclosure. Trademarks are shown in upper case. Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (it may or may not be present).

As used herein, the term “monomer” refers to a relatively simple compound, usually containing carbon and of low molecular weight, which can react to form a polymer by combining with like molecules or with other similar molecules or compounds. As used herein, the term “comonomer” refers to a monomer that is copolymerized with at least one different monomer in a copolymerization reaction, the result of which is a copolymer.

As used herein, the term “polymer” refers to the product of a polymerization reaction, and is inclusive of homopolymers, copolymers, terpolymers, tetrapolymers, etc.

As used herein, the term “homopolymer” is used with reference to a polymer resulting from the polymerization of a single monomer, i.e., a polymer consisting essentially of a single type of repeating unit.

As used herein, the term “copolymer” refers to polymers formed by the polymerization reaction of at least two different monomers. As used herein, the term “copolymerization” refers to the simultaneous polymerization of two or more monomers. The term “copolymer” is also inclusive of random copolymers, block copolymers, and graft copolymers.

As used herein, the term “polymerization” is inclusive of homo-polymerizations, copolymerizations, terpolymerizations, etc., and includes all types of copolymerizations such as random, graft, block, condensation, etc. In general, the polymers, in the structures used in accordance with the present invention, can be prepared in accordance with any suitable polymerization process, including slurry polymerization, gas phase polymerization, and high pressure polymerization processes.

The compositions of the invention are multilayer structures comprising at least three layers such as a multilayer structure comprising a first layer of polymer, a second adhesive layer, and a third polymer layer. The polymer layers may be of the same material or can be different materials. One or more of the layers may comprise what is referred to in the composite structure art as a “structural resin”, and one or more of the layers may comprise what is referred to as a “barrier resin”. In the art there is often a distinction made between structural resins and barrier resins. The resins used as barrier layers are utilized in composite structures to provide barriers to oxygen, water, water vapor and carbon dioxide, for a variety of applications requiring barriers against these materials.

One group of polymers for use in the invention includes but is not restricted to materials such as nylon 6, MXD6 nylon, amorphous nylon, ethylene/vinyl alcohol copolymers, ethylene/norbornene copolymers, polyvinylidene chloride, polypropylene, polyethylene, ethylene copolymers, ionomers, polystyrene, polyamides and polyesters. The polyesters may be liquid crystal polymers.

Another group of polymers for use in the invention includes but is not restricted to materials such as nylon 6, MXD6 nylon, amorphous nylon, ethylene/vinyl alcohol copolymers, ethylene/norbornene copolymers, polyvinylidene chloride, polypropylene, ethylene copolymers, ionomers, polystyrene, polyamides and polyesters.

Polyesters for use in the invention include, for example, (a) polycarbonates; (b) amorphous polyester of terephthalic acid, isophthalic acid, 1,4-cyclohexanedimethanol, and ethylene glycol; (c) poly(glycolic acid); d) polyethylene terephthalate; (e) polyethylene naphthalate; (f) polytrimethylene terephthalate; (g) poly(lactic acid); (h) polyesters from polymerization of bisphenol-A, isophthalic acid, and terephthalic acid; (i) polybutylene terephthalate; (O) polyester elastomer copolymers of terephthalic acid, butanediol, and polyalkylene glycol; (k) polyethylene carbonates from copolymerization of carbon dioxide and epoxide monomers; (I) polyesters from copolymerization of terephthalic acid or esters thereof with 1,4-cyclohexanedimethanol; and (m) polyesters based on isosorbide.

Of the list of polymers for use in the invention presented above, those utilized for barrier layers typically include nylon 6, MXD6 nylon, amorphous nylon (such as SELAR® PA from DuPont), ethylene/vinyl alcohol copolymer (EVOH), ethylene/norbornene copolymers (COC's), polyvinylidene chloride (PVDC) and polyesters. Particularly effective barrier resins are aromatic polyesters made by copolymerization of polyethylene terephthalate, hydroxybenzoic acid, hydroxynaphthoic acid 4,4′-biphenol by the methods described in U.S. patent application Publication No. 2004/0058092, which is incorporated herein by reference. However, up until the present time there has been difficulty in providing adhesive tie resins effective in bonding these polyesters.

A particularly preferred polymer for use in the composite structures of the present invention is a copolymer comprising repeat units of the formulae

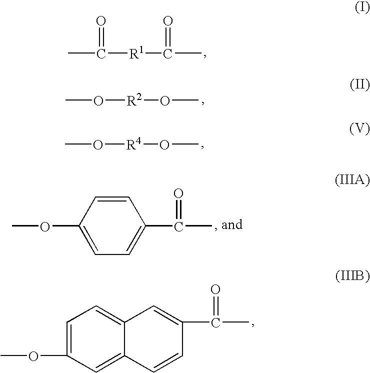

wherein:

each R¹ is independently hydrocarbylene or substituted hydrocarbylene;

each R² is independently saturated hydrocarbylene or substituted saturated hydrocarbylene;

each R⁴ is independently arylene or substituted arylene;

(V) is about 0.4 to about 32 mole percent of the total of (I) present;

the molar ratio of (I):[(II)+(V)] is about 1.0:1.0;

the molar ratio of (I):[(IIIA)+(IIIB)] is about 1.0:1.0 to about 1.0:4.0; and

the molar ratio of (IIIA):(IIIB) is about 5:1 to about 1:2.

More preferred is the above copolymer where from 90 to 100 mole percent of R¹ is p-phenylene, and from 0 to 10 mole percent of R¹ is m-phenylene;

from 90.0 to 100 mole percent of R² is —CH₂CH₂— and from 0 to 10 mole percent of R² is —CH₂CH₂OCH₂CH₂—;

each R⁴ is 4,4′-biphenylene;

(V) is from about 1 to about 3 mole percent of the total of (I) present;

the molar ratio of (I):[(II)+(V)] is about 1.0:1.0; and the total amount of the repeat unit (I+V) plus the repeat unit (I+II) is from about 25 to about 35 mole percent of the copolymer;

the amount of (IIIA) is from about 45 to about 55 mole percent of the copolymer; and

the amount of (IIIB) is from about 15 to about 25 mole percent of the copolymer. Polymers of this structure and methods for their preparation are disclosed in U.S. patent application Publication No. 2004/0058092, which is incorporated herein by reference.

Particularly preferred polyesters for use in the invention are: (a) those prepared from monomers comprising polyethylene terephthalate, p-hydroxybenzoic acid, 6-hydroxy-2-naphthoic acid and 4,4′-biphenol; (b) those prepared from monomers comprising p-hydroxybenzoic acid, 6-hydroxy-2-naphthoic acid, 4,4′-biphenol, resorcinol and terephthalic acid or ester thereof; (c) those prepared from monomers comprising p-hydroxybenzoic acid, 6-hydroxy-2-naphthoic acid, isophthalic acid or an ester thereof, terephthalic acid or an ester thereof, and hydroquinone; and (d) those prepared from monomers comprising p-hydroxybenzoic acid, m-hydroxybenzoic acid and 6-hydroxy-2-naphthoic acid. Polyesters of type (a) are described in U.S. patent application Publication No. 2004/0058092, which is incorporated herein by reference. Polyesters of type (b), (c) and (d) are described in U.S. Pat. Nos. 6,132,884, 6,514,611 and 6,666,990 respectively, all of which are incorporated herein by reference.

With regard to the adhesive or tie resin of the invention, polymers and copolymers containing epoxide groups are known in the art, and can be prepared by direct or graft polymerization of monomers containing epoxy groups. Particularly preferred for the invention are polymers and copolymers where the epoxide groups comprise glycidyl groups. Glycidyl-containing ethylene copolymers and modified copolymers useful in the present invention are known in the polymer art and can readily be produced by the concurrent reaction of monomers in accordance with U.S. patent application Publication No. 2003/0087997, the entire disclosure of which is incorporated herein by reference.

The tie resin, or adhesive layer polymer, for use in the invention is preferably a copolymer that comprises from about 55 to about 95 weight % ethylene, from 0 to about 35 weight % methacrylate or acrylate ester and from about 0.1 to 10 weight %, preferably 2 to about 10 weight %, more preferably from about 3 to about 7 weight %, and most preferably from about 4 to about 6 weight %, comonomer that contains glycidyl moieties based on the total weight of the ethylene copolymer. The glycidyl moiety may be represented by the following formula:

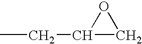

Preferred glycidyl moieties are glycidyl acrylate and glycidyl methacrylate, and the most preferred is glycidyl methacrylate. The acrylate or methacrylate ester, when present, is preferably a C₁-C₁₀ alkyl methacrylate or acrylate, more preferably n-butyl acrylate. Preferably, the adhesive layer polymer contains from about 1 to about 35 weight %, alternatively from about 5 to about 25 weight % and alternatively from about 25 to about 35 weight % polymerized n-butyl acrylate.

Preferred epoxy-functionalized ethylene copolymers useful in this invention may be represented by the formula: E/X/Y, where E is the copolymer unit —(CH₂CH₂)— derived from ethylene; X is the copolymer unit —(CH₂CR₁R₂)—, where R₁ is hydrogen, methyl, or ethyl, and R₂ is carboalkoxy, acyloxy, or alkoxy of 1 to 10 carbon atoms (X for example is derived from alkyl acrylates, alkyl methacrylates, vinyl esters, and alkyl vinyl ethers); and Y is the copolymer unit —(CH₂CR₃R₄)—, where R₃ is hydrogen or methyl and R₄ is carboglycidoxy or glycidoxy (Y for example is derived from glycidyl acrylate or glycidyl methacrylate). For purposes of this invention the epoxy-containing comonomer unit, Y, may also be derived from vinyl ethers of 1 to 10 carbon atoms (e.g., glycidyl vinyl ether) or mono-epoxy substituted di-olefins of 4 to 12 carbon atoms. The R₄ in the above formula includes an internal glycidyl moiety associated with a cycloalkyl monoxide structure; e.g., Y derived from vinyl cyclohexane monoxide. Preferably, X is a C₁₋₁₀ alkyl acrylate, particularly iso-butyl acrylate, n-butyl acrylate, iso-octyl acrylate, or methyl acrylate. Preferably, Y is selected from glycidyl acrylate or glycidyl methacrylate.

The adhesive layer may contain ingredients in addition to the adhesive layer copolymer described above. Particularly useful additional ingredients are elastomeric materials such as ethylene/propylene/diene terpolymer rubber (EPDM), polyethylene plastomers, ethylene/propylene rubber (EP rubber) and very low density polyethylene (VLDPE). The elastomeric materials are preferably used at levels up to about 25% weight %, more preferably up to about 20 weight %, based on the weight of the adhesive layer copolymer.

Other ingredients particularly useful in the adhesive layer are tackifying resins, preferably used at levels up to about 20 weight %, more preferably up to about 15 weight % based on the weight of the adhesive layer copolymer. Suitable tackifying resins may be selected from: (i) alicyclic or aliphatic hydrocarbon resins; (ii) aromatic hydrocarbon resins; (iii) rosin and rosin derivatives; and (iv) terpene resins, or mixtures thereof. These tackifying resins will generally have a ring-and-ball softening temperature (ASTM E-2858T) of about 0 to about 150° C., preferably about 75 to about 140° C.

The tackifying resins employed in the present invention are well known products available from commercial sources. Rosin tackifiers are described in the Kirk Othmer Encyclopedia of Chemical Technology, Interscience Publishers, Second Edition, Volume 17, pages 475-509. They include naturally occurring rosins and chemically modified rosin derivatives obtained by hydrogenation, dehydrogenation, isomerization, and the like. Rosin derivatives includes rosin esters and rosin acids.

Rosin acids are typically derived from tall oil and can be mixtures of so called abietic types and primary types. Rosin esters are formed by esterifying rosin acid with a di-, tri-, or tetra-hydroxy aliphatic alcohol such as ethylene glycol, propylene glycol, glycerin, or pentaerythritol. The terpene resins are generally prepared by the polymerization of terpene hydrocarbons in the presence of Friedel-Crafts catalysts at moderately low temperatures. Petroleum resins, including aliphatic, alicyclic, and aromatic hydrocarbon resins, are described in the Kirk Othmer Encyclopedia of Chemical Technology, Interscience Publishers, Third Edition, Volume 12, page 852. They are generally prepared by polymerization of 4-10 carbon atom hydrocarbons by selected Friedel Crafts catalysts. Higher or lower hydrocarbons may also be present. The product may be further partially or fully hydrogenated. Suitable aromatic resins can be prepared from polymerization of alpha methyl styrene, vinyl toluene, and/or indene monomers. Particularly preferred resins are aromatic resins.

The adhesive resin composition is prepared by blending the components described above by any suitable means, such as by melt blending, or extruding, or any other means known in the art.

In addition to the above mentioned components, the adhesive resin may contain small amounts of other materials commonly used and known in the art, such as antioxidants, stabilizers, slip additives, fillers and the like.

One component that can be particularly useful is zeolite. A zeolite can be optional in the practice of the present invention, but is preferably used at levels of from 0.5 to about 5 weight % based on the weight of the adhesive resin. Zeolites are hydrated aluminosilicates of the alkaline and alkaline-earth metals. About 40 natural zeolites have been identified during the past 200 years; the most common are analcime, chabazite, clinoptilolite, erionite, ferrierite, heulandite, laumontite, mordenite, and phillipsite. More than 150 zeolites have been synthesized. In the present invention, zeolites serve to scavenge residual unreacted monomers, particularly glycidyl methacrylate and n-butyl acrylate, in order to avoid organoleptic problems which might arise in food packaging or pharmaceutical packaging applications if large amounts of unreacted monomer were present. It has been found, for example, that incorporation and dispersion of 1 weight % of ABSCENTS®3000 zeolite into the film of ethylene/n-butyl acrylate/glycidyl methacrylate copolymer reduces the level of unreacted glycidyl methacrylate to less than about 20 ppm, preferably less than about 15 ppm.

Reduction of the levels of residual glycidyl methacrylate can also be accomplished by water-washing/devolatilization using an extractor extruder as described in the Examples below. The water-washing/devolatilization process also reduces the unreacted monomer levels to less than about 20 ppm, preferably less than about 10 ppm. The adhesive properties of the water-washed/devolatilized polymers are substantially retained. Because of the well known ease of ring opening hydrolysis of epoxides, it is surprising that the use of water at high temperatures to remove residual unreacted monomer does not destroy the adhesive properties of the adhesive copolymers containing glycidyl methacrylate monomer.

For copolymers also containing n-butyl acrylate monomer, these two treatments (incorporation of zeolite or water-washing/devolatilization) also reduce the level of unreacted residual n-butyl acrylate to less than about 20 ppm, preferably less than about 10 ppm.

The final adhesive composition can be used directly, for example in a melt coextrusion, or it can be extruded in rope or pellet form or reduced to a chip or powder form. It can be cast or extruded into a film or web form for subsequent use. In such shaped forms, it can be placed between the substances to be bonded and then activated by heat and pressure. A preferred method of application is via coextrusion with the other polymeric materials such as structure and barrier polymers. Although these compositions can be applied in any thickness the practitioner finds expedient, it is preferred to employ a thickness of from about 0.01 to about 10 mils.

The multilayer structures of the invention are readily prepared either by lamination of the polymer layers, the adhesive being applied as described above, or preferably by coextrusion of the various polymer and adhesive layers.

One critical factor in coextrusion processes is the need for the flow of the adhesive layer to match the flow of the other polymer layers during extrusion. In the case of the present invention, this can be accomplished by appropriate formulation with elastomers and tackifying resin.

There are a variety of potential uses for the multilayer composites of the invention that take advantage of their constant oxygen barrier before and after retorting and their excellent moisture barrier properties. These include microwavable cups for retorted soups, stews and liquid meals, blister packaging for pharmaceuticals, flexible wrapping for foods and replacements for metals cans and glass jars.

The following Examples are presented to more fully demonstrate and illustrate various aspects and features of the present invention. As such, they are intended to further illustrate the differences and advantages of the present invention, but are not meant to be unduly limiting.

### EXAMPLES

Materials

Polymer A: An aromatic polyester made by copolymerization of 34 weight % polyethylene terephthalate, 41 weight % hydroxybenzoic acid, 22 weight % hydroxynaphthoic acid and 2 weight % 4,4′-biphenol by the methods described in U.S. patent application Publication No. 2004/0058092.

Adhesive Layer Copolymer A: Ethylene/1.8 weight % glycidyl methacrylate (GMA) copolymer, prepared by methods described in U.S. patent application Publication No. 2003/0087997.

Adhesive Layer Copolymer B: Ethylene/5.25% weight % GMA/28 weight % n-butyl acrylate (nBA) copolymer, prepared by methods described in U.S. patent application Publication No. 2003/0087997.

Adhesive Layer Copolymer C: Ethylene/5.25% weight % GMA/28 weight % nBA copolymer with anti-block additive, prepared by methods described in U.S. patent application Publication No. 2003/0087997.

Adhesive Layer Copolymer D: Ethylene/9 weight % GMA/28 weight % nBA copolymer, prepared by methods described in U.S. patent application Publication No. 2003/0087997.

Adhesive Layer Copolymer E: Maleic anhydride grafted polypropylene, manufactured by DuPont.

NORDEL®IP3720P: EPDM rubber, available from DuPont Dow Elastomers.

REGALITE®1125: Hydrogenated hydrocarbon resin tackifier, available from Eastman Chemical Co.

Procedures

Adhesion of the candidate copolymers to Polymer A was tested by the following procedure.

A 1.5-mil cast film of Polymer A was prepared on a 28 mm twin-screw extruder. Films of the adhesive polymers for evaluation were prepared either by the same cast film process (2-mils) or by pressing films (2-4 mils) in a laboratory press using TEFLON® fluoropolymer film to prevent sticking to the metal platens.

A sandwich structure of Polymer A film/adhesive polymer film/Polymer A film was constructed from 1-inch wide films cut in the machine direction. The assembly was placed in a Sentinel heat sealer with flat heat seal bars. TEFLON cloth was placed between the Polymer A and the seal bar to prevent the Polymer A from sticking to the bar during sealing. Preliminary experiments were conducted to find that the optimal sealing temperature, and dwell time was 3 seconds at 485° F. (251° C.). Some results are also reported at 1.5-sec dwell.

Once sealed, the samples were cooled in air to room temperature, stored at 50% relative humidity and 23° C. for one day, and tested for heat seal strength. The specimens were pulled in a “T-peel” configuration at 12 inches/min. The average peel strength of 3 to 5 specimens is reported along with standard deviation. In almost all cases, the failure was a clean peel from the Polymer A.

### Example 1

In this example adhesive layer copolymers were tested for adhesion to Polymer A by the methods described above. The results are in Table 1.

TABLE 1

| | | Heat Seal Strength at | | | |
|---|---|---|---|---|---|
| | | 252° C. (g/25 mm) | | | |
| | | 1.5 Second | | 3.0 Second | |
| | | Dwell | | Dwell | |
| | | Time | | Time | |
| Copolymer | Film Type | Avg. | Std. Dev. | Avg. | Std. Dev. |
| Adhesive Layer | Cast | 0 | | 0 | |
| Copolymer E | | | | | |
| Adhesive Layer | Cast | 0 | | 0 | |
| Copolymer A | | | | | |
| Adhesive Layer | Cast | | | 897 | 80 |
| Copolymer B | | | | | |
| Adhesive Layer | Cast | 336 | 127 | 680 | 36 |
| Copolymer B | | | | | |
| Adhesive Layer | Pressed | | | 170 | 36 |
| Copolymer C | | | | | |
| Adhesive Layer | Cast | | | 621 | 101 |
| Copolymer D | | | | | |

The poor adhesion observed with Adhesive Polymer A as compared to that observed with Adhesive Polymer B, Adhesive Polymer C and Adhesive Polymer D demonstrates the preference for a glycidyl moiety level of at least about 2 weight %

The absence of adhesion observed with Adhesive Polymer E shows that conventional anhydride based adhesive layers resins do not bond well to Polymer A.

### Example 2

In this example, ethylene copolymers containing glycidyl moieties were formulated with additional ingredients and tested for adhesion as by the methods described above. The formulations are described in Table 2. The adhesive test data are in Table 3.

TABLE 2
Formulated Ethylene Copolymers

| Formulation | | |
|---|---|---|
| No. | Formulation | Explanation |
| 1 | 80% Adhesive Layer | Adjust viscosity by addition |
| | Copolymer B, 20% | of EPDM to Adhesive Layer |
| | NORDEL ® 3720P | Copolymer B |
| 2 | 90% Adhesive Layer | Use of a tackifying resin with |
| | Copolymer B, 10% | Adhesive Layer Copolymer B |
| | REGALITE ® 1125 | |
| 3 | 70% Adhesive Layer | Use of EPDM and a |
| | Copolymer B, 20% | tackifying resin with Adhesive |
| | NORDEL ® IP3720P, | Layer Copolymer B |
| | 10% REGALITE ® 1125 | |

TABLE 3

| | | Heat Seal Strength at | | | |
|---|---|---|---|---|---|
| | | 252° C. (g/25 mm) | | | |
| | | 1.5 Second | | 3.0 Second | |
| | | Dwell | | Dwell | |
| | | Time | | Time | |
| Formulation No. | Film Type | Avg. | Std. Dev. | Avg. | Std. Dev. |
| 1 | Cast | | | 622 | 61 |
| 2 | Cast | | | 670 | 199 |
| 3 | Cast | | | 910 | 82 |

These results demonstrate that a glycidyl moiety containing adhesive layer polymer that contains at least about 2 weight % glycidyl moiety can be diluted with EPDM and/or tackifying resin with substantial retention of adhesion to liquid crystal polymer.

### Example 3

This example illustrates two methods for reducing residual glycidyl methacrylate levels in copolymers containing it as a comonomer.

A sample of Adhesive Layer Copolymer B pellets was analyzed for residual GMA using gas chromatography. The value found was 550 ppm. When a blown film was made from the pellets, the GMA level was found to have dropped to 25 ppm. Adding 1 weight % ABSECENTS®3000 zeolite was found to reduce the GMA level in the film to 12 ppm

A sample of Adhesive Layer Copolymer C with an initial residual GMA level of 650 ppm and initial residual n-butyl acrylate level of 100 ppm was water washed using an extractor/extruder. The barrel temperatures were 220° C. Water was injected into two ports of the devolatilizing extruder. The residual GMA level after one pass was about 11 ppm, and after two passes about 2.5 ppm. The residual n-butyl acrylate level after one pass was 2 ppm, and after two passes 0.2 ppm.

### Example 4

In this example the samples with lowered residual GMA levels prepared in Example 3 were evaluated for adhesion to Polymer A and the results are reported in Table 4. The results indicate that reduction of the residual glycidyl methacrylate levels in the adhesive layer polymers of the invention did not substantially affect their adhesive performance.

TABLE 4

| | | Heat Seal Strength at | | | |
|---|---|---|---|---|---|
| | | 252° C. (g/25 mm) | | | |
| | | 1.5 Second | | 3.0 Second | |
| | | Dwell | | Dwell | |
| | Film | Time | | Time | |
| Formulation | Type | Avg. | Std. Dev. | Avg. | Std. Dev. |
| Adhesive Layer | Cast | 353 | 172 | 680 | 136 |
| Copolymer B with 1% | | | | | |
| ABSCENTS ® 3000 | | | | | |
| Adhesive Layer | Pressed | | | 290 | 36 |
| Copolymer C, | | | | | |
| water/vacuum | | | | | |
| extracted | | | | | |
| Adhesive Layer | Cast | | | 95 | 36 |
| Copolymer C, | | | | | |
| water/vacuum | | | | | |
| extracted | | | | | |

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the disclosure.

What is claimed is:

1. A multilayer composite structure having at least three layers wherein two of the at least three layers are each adhered to a third layer, which is an intervening adhesive layer comprising:
(a) a thermoplastic copolymer obtained by copolymerization of monomers, wherein from about 55 to about 95 weight % of the monomers are ethylene, from 0 to about 35 weight % of the monomers are alkyl methacrylate or alkyl acrylate, and from about 0.1 to about 10 weight % of the monomers are epoxide-containing monomers; (b) an optional elastomeric polymer; (c) an optional tackifying resin; and (d) an optional zeolite.

2. The multilayer composite structure of claim 1 wherein the epoxide containing monomer comprises a glycidyl moiety.

3. The multilayer composite structure of claim 2 wherein the epoxide containing monomer comprises glycidyl methacrylate or glycidyl acrylate, wherein the adhesive layer copolymer contains less than about 30 ppm of unreacted glycidyl methacrylate or glycidyl acrylate.

4. The multilayer composite structure of claim 3 wherein the epoxide containing monomer comprises glycidyl methacrylate, and the alkyl methacrylate or alkyl acrylate, if present, comprises n-butyl acrylate.

5. The multilayer composite structure of claim 4 wherein the adhesive layer comprises from about 1 to about 35 weight % copolymerized n-butyl acrylate, and wherein the adhesive layer includes less than about 10 ppm residual n-butyl acrylate.

6. The multilayer composite structure of claim 5 wherein the adhesive layer comprises from about 25 to about 35 weight % copolymerized n-butyl acrylate and includes less than about 20 ppm of residual glycidyl methacrylate.

7. The multilayer composite structure of claim 1 wherein at least one of the layers adhered to said adhesive layer comprises a resin selected from the group consisting of nylon 6, MXD6 nylon, amorphous nylon, ethylene/vinyl alcohol copolymers, ethylene/norbornene copolymers, polyvinylidene chloride, polypropylene, polyethylene, ethylene copolymers, ionomers, polystyrene, polyamides, polyesters and copolyesters.

8. The multilayer composite structure of claim 7 wherein at least one of the layers adhered to said adhesive layer comprises a polyester selected from the group consisting of: (a) polycarbonates; (b) amorphous polyester of terephthalic acid, isophthalic acid, 1,4-cyclohexanedimethanol, and ethylene glycol; (c) poly(glycolic acid); d) polyethylene terephthalate; (e) polyethylene naphthalate; (f) polytrimethylene terephthalate; (g) poly(lactic acid); (h) polyesters from polymerization of bisphenol-A, isophthalic acid, and terephthalic acid; (i) polybutylene terephthalate; (j) polyester elastomer copolymers of terephthalic acid, butanediol, and polyalkylene glycol; (k) polyethylene carbonates from copolymerization of carbon dioxide and epoxide monomers; (I) polyesters from copolymerization of terephthalic acid or esters thereof with 1,4-cyclohexanedimethanol; (m) copolyesters based on propylene glycol; and (n) polyesters based on isosorbide.

9. The multilayer composite structure of claim 7 wherein the polyester is a liquid crystal polymer.

10. The multilayer composite structure of claim 7 wherein at least one of the layers adhered to said adhesive layer comprises a copolymer comprising repeat units of the formulae 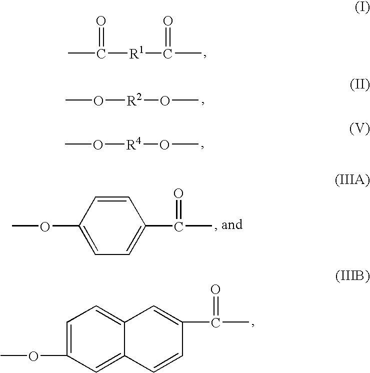
wherein:
(1) each R¹ is independently hydrocarbylene or substituted hydrocarbylene;
(2) each R² is independently saturated hydrocarbylene or substituted saturated hydrocarbylene;
(3) each R⁴ is independently arylene or substituted arylene;
(4) (V) is about 0.4 to about 32 mole percent of the total of (I) present;
(5) the molar ratio of (I):[(II)+(V)] is about 1.0:1.0;
(6) the molar ratio of (I):[(IIIA)+(IIIB)] is about 1.0:1.0 to about 1.0:4.0; and
(7) the molar ratio of (IIIA):(IIIB) is about 5:1 to about 1:2.

11. The multilayer composite structure of claim 10 wherein:
(i) from about 90 to about 100 mole percent of R¹ is p-phenylene, and from about 0 to about 10 mole percent of R¹ is m-phenylene;
(ii) from about 90 to about 100 mole percent of R² is —CH₂CH₂— and from about 0 to about 10 mole percent of R² is —CH₂CH₂OCH₂CH₂—;
(iii) each R⁴ is 4,4′-biphenylene;
(iv) (V) is from about 1 to about 3 mole percent of the total of (I) present;
(v) the molar ratio of (I):[(II)+(V)] is about 1.0:1.0, and the total amount of the repeat unit (I+V) plus the repeat unit (I+II) is from about 25 to about 35 mole percent of said copolymer;
(vi) the amount of (IIIA) is from about 45 to about 55 mole percent of said copolymer; and
(vii) the amount of (IIIB) is from about 15 to about 25 mole percent of said copolymer.

12. The multilayer composite structure of claim 11 wherein:
(i) the total amount of the repeat unit (I+V) plus the repeat unit (I+II) is from about 28 to about 32 mole percent of said copolymer;
(ii) the amount of (IIIA) is from about 48 to about 52 mole percent of said copolymer; and
(iii) the amount of (IIIB) is from about 18 to about 22 mole percent of said copolymer.

13. The multilayer composite structure of claim 7 wherein at least one of the layers adhered to said adhesive layer is a polyester prepared from monomers selected from the group of monomers comprising polyethylene terephthalate, p-hydroxybenzoic acid, 6-hydroxy-2-naphthoic acid and 4,4′-biphenol.

14. The multilayer composite structure of claim 7 wherein at least one of the layers adhered to said adhesive layer is a polyester prepared from monomers selected from the group of monomers comprising p-hydroxybenzoic acid, 6-hydroxy-2-naphthoic acid, 4,4′-biphenol, resorcinol and terephthalic acid or ester thereof.

15. The multilayer composite structure of claim 7 wherein at least one of the layers adhered to said adhesive layer is a polyester prepared from monomers selected from the group of monomers comprising p-hydroxybenzoic acid, 6-hydroxy-2-naphthoic acid, isophthalic acid or an ester thereof, terephthalic acid or an ester thereof, and hydroquinone.

16. The multilayer composite structure of claim 7 wherein at least one of the layers adhered to said adhesive layer is a polyester prepared from monomers selected from the group of monomers comprising p-hydroxybenzoic acid, m-hydroxybenzoic acid and 6-hydroxy-2-naphthoic acid.

17. The multilayer composite structure of claim 1 wherein the optional elastomeric polymer is selected from the group consisting of ethylene/propylene/diene terpolymer rubber, polyethylene plastomers, ethylene/propylene rubber and very low density polyethylene.

18. The multilayer composite structure of claim 1 wherein the optional tackifying resin has a ring and ball softening point, as determined according to ASTM E-2858T, of from about 0° to about 150° C. and is selected from the group consisting of alicyclic or aliphatic hydrocarbon resin, aromatic hydrocarbon resins, rosin and rosin derivatives, and terpene resins.

19. The multilayer composite structure of claim 1 wherein the zeolite is present at a level of from about 0.5 to about 5 weight % based on the weight of the adhesive layer.

20. An article comprising the multilayer composite structure of claim 1.

21. The article of claim 20 wherein the article is one selected from the group consisting of retortable packages, blister packages and flexible wrapping film.

22. A copolymer obtained by the copolymerization of monomers, wherein the monomers comprise from about 55 to about 95 weight % ethylene, from 0 to about 35 weight % alkyl methacrylate or alkyl acrylate and from about from about 0.1 to about 10 weight % glycidyl methacrylate, and wherein the copolymer includes less than about 30 ppm residual glycidyl methacrylate.

23. The copolymer of claim 22 comprising from about 25 to about 35 weight % n-butyl acrylate as the alkyl acrylate, wherein the copolymer contains less than about 20 ppm residual n-butyl acrylate.

24. A blend comprising a copolymer obtained by the copolymerization of monomers, wherein the monomers comprise from about 55 to about 95 weight % ethylene, from 0 to about 35 weight % alkyl methacrylate or alkyl acrylate and from about from about 0.1 to about 10 weight % glycidyl methacrylate, and wherein the copolymer includes less than about 30 ppm residual glycidyl methacrylate.

25. A process for reducing the amount of residual alkyl acrylate and/or alkyl methacrylate monomer in a copolymer comprising glycidyl methacrylate units, the process comprising the step of washing the copolymer with heated water in a devolatilizing extruder.

26. A process for reducing residual alkyl acrylate and/or alkyl methacrylate monomer in a copolymer comprising ethylene and glycidyl methacrylate units, the process comprising the step of: adding to and dispersing into the copolymer from about 0.5 to about 5 weight % zeolite based on the weight of the copolymer.
